(19) United States
(12) Patent Application Publication
(10) Pub. No.: US 2006/0210057 A1
(43) Pub. Date: Sep. 21, 2006

(54) Supplying power over four pairs of conductors in communication cable

(75) Inventor: Clayton Reynolds Stanford, Summerland, CA (US)

Correspondence Address: MCDERMOTT WILL & EMERY LLP, 600 13TH STREET, N.W., WASHINGTON, DC, 20005-3096, US

(73) Assignee: LINEAR TECHNOLOGY CORPORATION

(21) Appl. No.: 11/336,971

(22) Filed: Jan. 23, 2006

Related U.S. Application Data
(60) Provisional application No. 60/646,509, filed on Jan. 25, 2005.

(51) Int. Cl. H04M 9/00

(52) U.S. Cl. 379/413

(57) ABSTRACT

A novel system for supplying power over a communication link, such as an Ethernet cable, having first and second wire sets each composed of two pairs of conductors. The system includes a power supply device, such as power sourcing equipment (PSE), configured for applying power to both the first wire set and the second wire set to deliver the power to a powered device.

This application claims priority of provisional U.S. patent application Ser. No. 60/646,509 filed on Jan. 25, 2005, and entitled “SYSTEM AND METHOD FOR SUPPORTING ADVANCED POWER OVER ETHERNET SYSTEM.”

1. Technical Field

This disclosure relates to power supply systems, and more particularly, to circuitry and methodology for providing power over four pairs of conductors in a system for supplying power over a communication link, such as an Ethernet link.

1. Background Art

Over the years, Ethernet has become the most commonly used method for local area networking. The IEEE 802.3 group, the originator of the Ethernet standard, has developed an extension to the standard, known as IEEE 802.3af, that defines supplying power over Ethernet cabling. The IEEE 802.3af standard defines a Power over Ethernet (PoE) system that involves delivering power over unshielded twisted-pair wiring from a Power Sourcing Equipment (PSE) to a Powered Device (PD) located at opposite sides of a link. Traditionally, network devices such as IP phones, wireless LAN access points, personal computers and Web cameras have required two connections: one to a LAN and another to a power supply system. The PoE system eliminates the need for additional outlets and wiring to supply power to network devices. Instead, power is supplied over Ethernet cabling used for data transmission.

As defined in the IEEE 802.3af standard, PSE and PD are non-data entities allowing network devices to supply and draw power using the same generic cabling as is used for data transmission. A PSE is the equipment electrically specified at the point of the physical connection to the cabling, that provides the power to a link. A PSE is typically associated with an Ethernet switch, router, hub or other network switching equipment or midspan device. A PD is a device that is either drawing power or requesting power. PDs may be associated with such devices as digital IP telephones, wireless network access points, PDA or notebook computer docking stations, cell phone chargers and HVAC thermostats.

The main functions of the PSE are to search the link for a PD requesting power, optionally classify the PD, supply power to the link if a PD is detected, monitor the power on the link, and disconnect power when it is no longer requested or required. A PD participates in the PD detection procedure by presenting a PoE detection signature defined by the IEEE 802.3af standard.

If the detection signature is valid, the PD has an option of presenting a classification signature to the PSE to indicate how much power it will draw when powered up. Based on the determined class of the PD, the PSE applies the required power to the PD.

The IEEE 802.3af standard describes power over the Ethernet by using the common mode voltage between 2 of the 4 twisted pairs of conductors within the CAT-5 cable. Current flows to the PD on one twisted pair and return to the PSE on the other twisted pair.

However, due to the resistance and associated heating of the cabling system, only a limited amount of power may be delivered over two twisted pairs. It would be desirable to deliver more power from the PSE to the PD that is achievable over two twisted.

### SUMMARY OF THE DISCLOSURE

The present disclosure offers a novel system for supplying power over a communication link, such as an Ethernet cable, having a first wire set composed of first and second pairs of conductors and a second wire set composed of third and fourth pairs of conductors. The system includes a power supply device, such as power sourcing equipment (PSE), configured for applying power to both the first wire set and the second wire set to deliver the power to a powered device.

In accordance with one aspect of the disclosure, the PSE may provide power to the PD over the first wire set in accordance with the IEEE 802.3af standard or another protocol, and the second wire set may be used for providing power from the PSE to the PD after the power over the first wire set is established.

A communication mechanism may carry out data communication between the PSE and the PD, before, during or after the power over the first wire set is established. This data communication may be performed over the first wire set or over the second wire set. The communication mechanism may be used to control applying power over the second wire set, and removing this power. The communication mechanism enables the PSE to deliver power over the first wire set during a period when power over the second wire set is being established.

A power monitoring mechanism may enable the PD to monitor power being delivered over the first and second wire sets. Based on the detected power, the PD may select providing power over the first or second wire set, or supplying power over the both wire sets.

A data monitoring mechanism may be used for monitoring data transmitted between the PSE and the PD over the first and second wire sets. The data monitoring mechanism may enable the PD to select data communication over the first or second wire set or data communication over the both wire sets.

A power switching mechanism may be provided for switching between a first power supply mode, in which power is provided over the first wire set and a second power supply mode, in which power is provided over the second wire set. The PSE may select between the first power supply mode and the second power supply mode based on data communication between the PSE and the PD.

Further, the data communication mechanism may provide switching between a first data communication mode, in which data communication is provided over the first wire set and a second data communication mode, in which data communication is provided over the second wire set.

The PD may have a first port for receiving power over the first wire set and a second port for receiving power over the second wire set. The PD may select between the first port and the second port based on quality of power supplied to the first port and the second port. Also, the PD may select the first port or the second port for data communication with the PSE based on quality of data at the first port and the second port.

PD usage of the first or second wire set may be selective or intermittent. Further, the power over the second wire set may be activated after a predetermined delay. Alternatively, the PD may be enabled for optional reception of power from the first wire set or the second wire set.

The PSE may provide the first wire set with power from a first power source and the second wire set with power from a second power source separate from the first power source. This may be used, for example, to implement a redundant power supply system.

Different power usage may be allowed on the first and second wire sets. Moreover, different maximum current limits and minimum current usage levels may be established for the first and second wire sets. Alternatively, the same requirements may be established for power usage, maximum current limit and minimum current usage for each of the first and second wire sets.

The first wire set may be designated as a master set, and the second wire set may be designated as a slave set. Power and/or data transferring operations associated with the slave set may be tied to respective operations associated with the master set. For example, power may be applied to the slave set once it was deemed acceptable to provide power to the master set.

In accordance with another aspect of the disclosure, a local area network may comprise at least a pair of network nodes, a network hub, and communication cabling for connecting the network nodes to the network hub to provide data communications. The communication cabling may have a first wire set composed of first and second pairs of conductors and a second wire set composed of third and fourth pairs of conductors. The network hub may have a power supply device for providing power to a load over both the first wire set and the second wire set.

In accordance with a method of the present disclosure, the following steps are carried out to supply power over a communication link including a first wire set composed of first and second pairs of conductors and a second wire set composed of third and fourth pairs of conductors:
establishing power over the first wire set, and
thereafter, establishing power over the second wire set.

Power over the first wire set may be established in accordance with the IEEE 802.3af standard or another protocol, whereas power supply over the second wire set may be provided in accordance with an extended protocol.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIG. 1 is a diagram illustrating a PoE system in accordance with the IEEE 802.3af standard.

FIG. 2 is a diagram illustrating a PoE system of the present disclosure.

FIG. 3 is a diagram illustrating a mechanism for supporting power transfer over 4 pairs of conductors in the PoE system of the present disclosure.

### DETAILED DISCLOSURE OF THE EMBODIMENTS

The present disclosure will be made using the example of supplying power over four pairs of conductors in a PoE system. It will become apparent, however, that the concepts described herein are applicable to any system for providing power over a cable having multiple conductors. For example, the power supply system of the present disclosure may be provided in a local area network (LAN) having a plurality of nodes, a network hub and communication cabling connecting the nodes to the network hub for providing data communications. The network hub may include a power supply device capable of supplying power to a load over four pairs of conductors within the communication cabling.

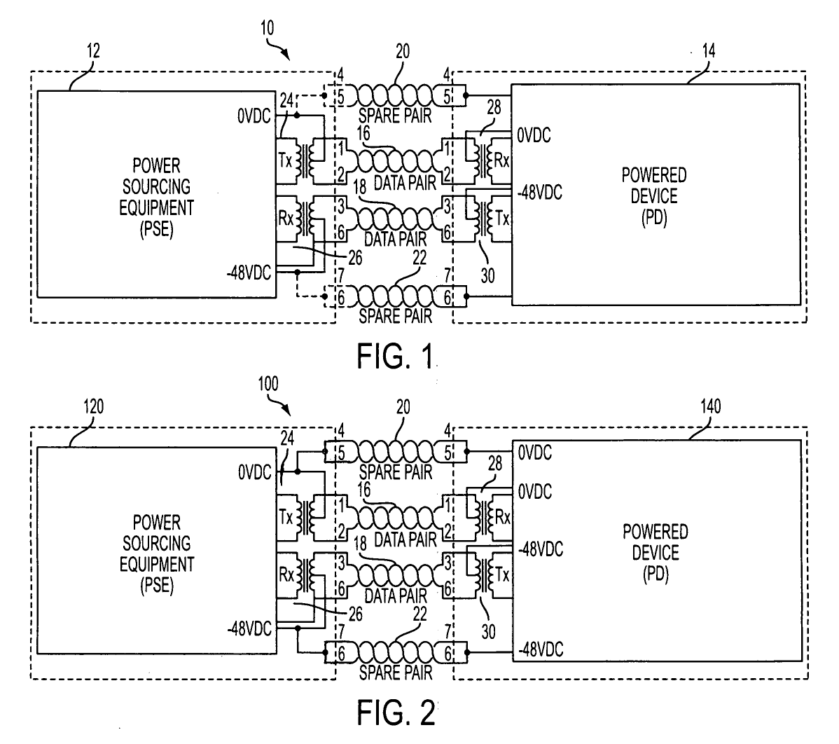

FIG. 1 illustrates a PoE system 10 described in the 802.3af standard. This system includes a PSE 12 that provides power to a PD 14 over the Ethernet link segment having four pairs of conductors—data pairs 16 and 18 and spare pairs 20 and 22. The data pairs 16 and 18 are respectively provided between data transformers 24 and 26 on the PSE side and data transformers 28 and 30 on the PD side. These data transformers may be used for connecting physical layer (PHY) devices involved in the Ethernet data transmission.

The 802.3af standard indicates that the PSE 12 may be placed in 2 locations with respect to the Ethernet link segment. In particular, a PSE defined as an endpoint PSE may be arranged within data terminal equipment (DTE) or a repeater having a media dependent interface (MDI) that supports data transmission. Another type of a PSE defined as a midpoint PSE may be located within the link segment that is distinctly separate from the MDI and is between the MDIs.

The 802.3af standard indicates that Alternative A or Alternative B may be used for transferring power over the Ethernet. Alternative A involves transferring power only over the data pairs 16 and 18, and usually is used for supplying power from endpoint PSEs. Alternative B provides transferring power only over the spare pairs 20 and 22, and usually is used for supplying power from midpoints PSEs. The standard indicates that both alternatives are not used on the same link segment simultaneously.

Hence, a 802.3af standard PoE system 10 may support transferring power only over two pairs of conductors, either over the data pairs 16 and 18 or over the spare pairs 20 and 22. However, due to the resistance and associated heating of the Ethernet cabling system, only a limited amount of power may be delivered over 2 pairs of conductors.

FIG. 2 illustrates a PoE system 100 in accordance with an embodiment of the present disclosure, in which power transferred from a PSE 120 to a PD 140 may be applied to both data and spare pairs of conductors of the same Ethernet link segment simultaneously to reduce the cable system resistance. As a result, the PSE 120 may be enabled to support high-power PDs requiring more power than available in accordance with the 802.3af standard. For example, a 48V DC voltage may be simultaneously applied from the PSE 120 to the data pairs 16 and 18, and the spare pairs 20 and 22 provided within an Ethernet link segment between the PSE 120 and the PD 140.

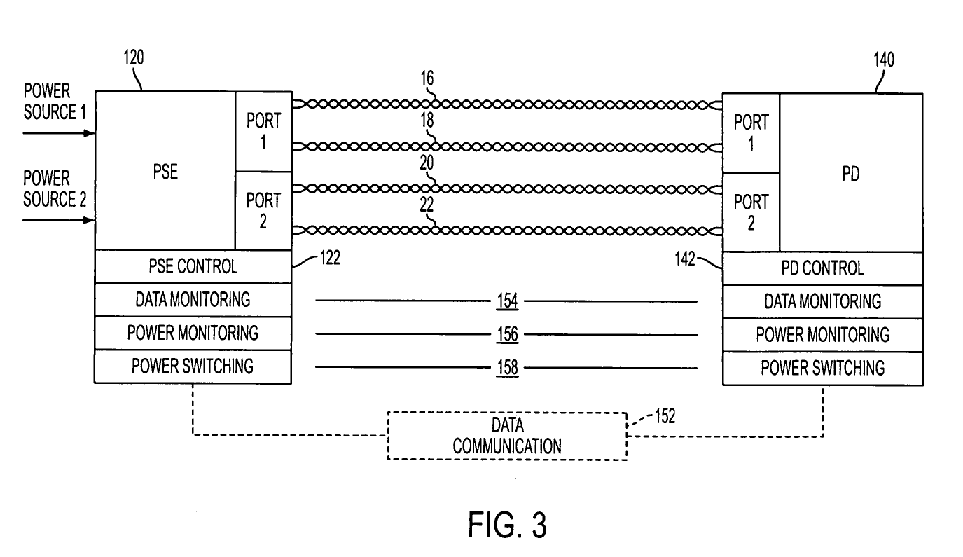

FIG. 3 illustrates a mechanism for supporting power transfer from the PSE 120 to the PD 140 over the data pairs 16 and 18, and the spare pairs 20 and 22. The PSE 120 may have port 1 for supplying power to the data pairs 16 and 18, and port 2 for supplying power to the spare pairs 20 and 22. The PD 140 also may have port 1 for receiving power delivered over the data pairs 16 and 18, and port 2 for receiving power from the spare pairs 20 and 22. A PSE control circuit 122 may control the power transfer procedure on the PSE side, whereas a PD control circuit 142 may control this procedure on the PD side.

As disclosed in more detail later, the power transfer support mechanism of the present disclosure may include a data communication mechanism 152 for supporting 1-way or 2-way data communication between the PSE 120 and the PD 140, a data monitoring mechanism 154 for monitoring data transferred between the PSE 120 and the PD 140, a power monitoring mechanism 156 for monitoring power delivered to the PD 140 over the data pairs 16 and 18, and over the spare pairs 20 and 22, and a power switching mechanism 158 for switching between supplying power over the data pairs 16 and 18, and supplying power over the spare pairs 20 and 22.

Various protocols may be used for establishing power over the data pairs 16 and 18, and the spare pairs 20 and 22. For example, the data pairs 16 and 18 may be designated by the PSE control circuit 122 as a primary wire set for transferring power from the PSE 120 to the PD 140, and the spare pairs 16 and 18 may be designated to be a secondary wire set. In this case, a procedure to establish power over the data pairs 16 and 18 may be carried out in accordance with the IEEE 802.3af protocol or another protocol. After establishing the power transfer over the data pairs 16 and 18, an extended protocol may be carried out between the PSE 120 and the PD 140 to establish power over the spare pairs 20 and 22 designated as a secondary wire set.

As discussed above, the IEEE 802.3af protocol involves a detection mode, during which a PD presents a PoE detection signature defined by the IEEE 802.3af standard. If the detection signature is valid, the PD has an option of presenting a classification signature to the PSE to indicate how much power it will draw when powered up. Based on the determined class of the PD, the PSE applies the required power to the PD over the data pairs 16 and 18.

Alternatively, the spare pairs 20 and 22 may be designated as a primary wire set for transferring power, and the data pairs 16 and 18 may be designated as a secondary wire set. In this case, the IEEE 802.3af protocol may be implemented to establish power over the spare pairs 20 and 22. This procedure may be followed by an extended protocol carried out between the PSE 120 and the PD 140 to establish power over the data pairs 16 and 18. In this example the IEEE 802.3af protocol is referenced, but other protocols, either standardized or proprietary may be used.

The data communication mechanism 152 may provide 1-way or 2-way data communication between the PSE 120 and the PSE 140 carried out to support the extended protocol. Although the PSE 120 and the PD 140 are non-data entities, which are not involved in transmission of Ethernet data, the data communication mechanism 152 may provide a way to communicate information between the PSE 120 and the PD 140. For example, the data communication mechanism 152 may enable the PSE 120 to detect a predefined electrical parameter of the PD 140 corresponding to the information that the PD 140 desires to present.

In particular, a predefined amount of current drawn by the PD 140 in response to supplying power from the PSE 120 or any other predefined event may be utilized to present the desired information. Alternatively, a predefined amount of current drawn by the PD 140 for a predefined time period may represent the desired information.

To acknowledge receipt of the information from the PD 140 or to supply the PD 140 with desired information, the PSE 120 may modify a power supply signal applied to the PD 140 or any other parameter detectable by the PD 140. For example, a power supply voltage applied to the PD 140 may be reduced to a predefined level for a predefined period of time to acknowledge receipt of the information from the PD 140 or to transmit desired information from the PSE 120 to the PD 140.

The data communication procedure supported by the data communication mechanism 152 is disclosed in more detail in copending U.S. patent application Ser. No. 11/273,255 filed on Nov. 15, 2005, entitled “PROVIDING DATA COMMUNICATION BETWEEN POWER SUPPLY DEVICE AND POWERED DEVICE IN SYSTEM FOR SUPPLYING POWER OVER COMMUNICATION LINK,” assigned to Linear Technology Corporation, assignee of the present application, and incorporated herewith by reference. The communication of this information may be performed during classification, after classification, during the power on sequence, or after the PD is up and running. The communication could be performed over the physical link using PSE line voltage to signal the PD and PD load current to signal the PSE. Alternately, the signaling could be performed over a higher-level communication layer such as using the Link Layer Discovery Protocol.

The data communication mechanism 152 enables the PoE system 100 to establish data communication between the PSE 120 and the PD 140 on either the primary wire set or the secondary wire set. Then, this data communication may be used to control using the secondary wire set for transferring power. Hence, the PD 140 is powered via the primary wire set when the extended power supply protocol over the secondary wire set is executed. A data communication scheme established using the data communication mechanism 152 may enable the PSE 120 to select whether to utilize the primary wire set or the secondary wire set for power transfer to the PD 140.

Also, the data communication mechanism 152 may implement a communication scheme for removing power from the secondary wire set. For example, the PD 140 may inform the PSE 120 that additional power is no longer required. In response to this information, the PSE 120 may remove power from the secondary wire set.

The power monitoring mechanism 156 enables the PD 140 to actively monitor the condition of power on the primary and secondary wire sets. When the PD 140 detects a predetermined power condition, it may autonomously switch wire sets. The power switching mechanism 158 may be used to provide switching of power between the primary wire set and the secondary wire set.

For example, the PD 140 may use the power monitoring to select a power input via the primary or secondary wire set based on the quality of power being transferred from the PSE 120, or to implement a redundant power system by enabling power over the primary wire set and the secondary wire set.

The data monitoring mechanism 154 enables the PD 140 to actively monitor the condition of data transferred via the primary and secondary wire sets to autonomously switch wire sets in response to a predetermined data condition. For example, based on the quality of data, the PD 140 may select whether to receive data via the primary wire set or via the secondary wire set. Also, a redundant data communication scheme may be established by transferring data via the primary wire set and the secondary wire set.

The power switching mechanism 158 may also enable the PSE 120 to control switching of power between the primary wire set and the secondary wire set to implement a more robust system. Also, the data communications mechanism 152 may be used by the PSE 120 to control switching data transmission between the primary wire set and the secondary wire set.

As discussed above, the PSE 120 may have port 1 for transferring power and/or data over the data pairs 16 and 18, and port 2 for transferring power and/or data over the spare pairs 20 and 22. Similarly, the PD 140 may have port 1 for receiving power and/or data from the data pairs 16 and 18, and port 2 for receiving power and/or data from the spare pairs 20 and 22. Using the power monitoring mechanism 156 and the data monitoring mechanism 154, the PD 140 may select which of these port to use as a power input depending on the quality of power and/or data received at the ports. Alternatively, the PD 140 may implement a redundant power supply system using both ports 1 and 2 for transferring power.

The PD control circuit 142 may be programmed to provide selective PD usage of the secondary wire set. For example, the PD 140 may use power transferred over the secondary wire set in response to predetermined conditions.

Further, the PD control circuit 142 may provide intermittent PD usage of the secondary wire set. For example, the PD 140 may use power delivered over the secondary wire set during predetermined time intervals.

Also, the PD control circuit 142 may be programmed to delay PD usage of power delivered over the secondary wire set. For example, a predetermined delay period may be set to delay using the secondary wire set after a predetermined event.

Finally, the PD control circuit 142 may provide optional PD usage of the secondary wire set to give the PD 140 a choice to use power delivered either over the primary wire set or over the secondary wire set, or power delivered over the both of these sets.

To create a robust power supply system for providing uninterruptible delivery of power to the PD 140, the PSE 120 may supply power to the primary and secondary wire sets from separate redundant sources. For example, power source 1 may be used by the PSE 120 for supplying power over the port 1, whereas power source 2 separate and independent from power source 1 may be used for providing power over the port 2.

To provide flexibility of the power supply system, different power usage may be allowed on the primary and secondary wire sets. For example, depending on power requirements during a given time interval, the secondary wire set may provide higher or lower power usage than the primary wire set. Moreover, different maximum current limits and minimum current usage levels may be established for the primary and secondary wire sets.

Alternatively, to provide interchangeability between the primary and secondary wire sets, the same requirements may be established for power usage, maximum current limit and minimum current usage for each of the primary and secondary wire sets. For example, the existing 802.3af requirements may be used on each of the primary and secondary wire sets. The PoE system of the present disclosure may be configured to be backward compatible with the IEEE 802.3af standard.

The PSE control circuit 122 may be programmed to designate one wire set as a master set, and the other wire set as a slave set. Power and/or data transferring operations associated with the slave set may be tied to respective operations associated with the master set. For example, power may be applied to the slave set once it was deemed acceptable to provide power to the master set.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

The embodiments described hereinabove are further intended to explain best modes known of practicing the invention and to enable others skilled in the art to utilize the invention in such, or other, embodiments and with the various modifications required by the particular applications or uses of the invention.

Accordingly, the description is not intended to limit the invention to the form disclosed herein. Also, it is intended that the appended claims be construed to include alternative embodiments.

What is claimed is:

1. A Power over Ethernet (PoE) system comprising:
Power Sourcing Equipment (PSE) for providing power to a powered device (PD), and
a first wire set composed of first and second pairs of conductors and a second wire set composed of third and fourth pairs of conductors,
the PSE being configured for applying the power to both the first wire set and the second wire set to deliver the power to the PD.

2. The PoE system of claim 1, wherein the PSE is configured for establishing power from the PSE to the PD over the first wire set, and for establishing power from the PSE to the PD over the second wire set after the power over the first wire set is established.

3. The PoE system of claim 1, wherein the PSE is configured for establishing power supply from the PSE to the PD over the first wire set, and for establishing power from the PSE to the PD over the second-wire set before the power over the first wire-set is established.

4. The PoE system of claim 1, wherein the PSE is configured for establishing power from the PSE to the PD over the first wire set, and for establishing power from the PSE to the PD over the second wire set during a procedure for establishing the power over the first wire set.

5. The PoE system of claim 1, wherein the PSE is configured for establishing power from the PSE to the PD over the first wire set in accordance with the IEEE 802.3af standard.

6. The PoE system of claim 1, further comprising a communication mechanism for providing communication between the PSE and the PD, after the power over the first wire set is established.

7. The PoE system of claim 6, wherein the communication mechanism is configured for providing communications over the first wire set.

8. The PoE system of claim 6, wherein the communication mechanism is configured for providing communications over the second wire set.

9. The PoE system of claim 6, wherein the communication mechanism is configured to control power over the second wire set.

10. The PoE system of claim 1, wherein power is delivered over the first wire set during a period when power over the second wire set is being established.

11. The PoE system of claim 1, further comprising a power monitoring mechanism configured to enable the PD to monitor power being delivered over the first wire set and over the second wire set.

12. The PoE system of claim 11, wherein the power monitoring mechanism is configured to enable the PD to select either power over the first wire set or power over the second wire set.

13. The PoE system of claim 11, wherein the power monitoring mechanism is configured to enable the PD to select power supply over the first wire set and power supply over the second wire set.

14. The PoE system of claim 1, further comprising a data monitoring mechanism for monitoring data transmitted between the PSE and the PD over the first wire set and over the second wire set.

15. The PoE system of claim 14, wherein the data monitoring mechanism is configured to enable the PD to select either data communication over the first wire set or data communication over the second wire set.

16. The PoE system of claim 14, wherein the data monitoring mechanism is configured to enable the PD to select data communication over the first wire set and data communication over the second wire set.

17. The PoE system of claim 1, further comprising a power switching mechanism for switching between a first power supply mode, in which power is provided over the first wire set and a second power supply mode, in which power is provided over the second wire set.

18. The PoE system of claim 17, wherein the PSE is configured for selecting between the first power supply mode and the second power supply mode based on data communication between the PSE and the PD.

19. The PoE system of claim 6, wherein the data communication mechanism is configured for switching between a first data communication mode, in which data communication is provided over the first wire set and a second data communication mode, in which data communication is provided over the second wire set.

20. The PoE system of claim 1, wherein the PD has a first port for receiving power over the first wire set and a second port for receiving power over the second wire set.

21. The PoE system of claim 20, wherein the PD is configured to select between the first port and the second port based on quality of power supplied to the first port and the second port.

22. The PoE system of claim 20, wherein the PD is configured to select the first port or the second port for data communication with the PSE based on quality of data at the first port and the second port.

23. The PoE system of claim 1, wherein the PD is configured for selectively receiving power over the first wire set or the second wire set.

24. The PoE system of claim 1, wherein the PD is configured for intermittently receiving power over the first wire set and the second wire set.

25. The PoE system of claim 1, wherein the PD is configured for receiving power over the second wire set a preset delay period after a predetermined event occurs.

26. The PoE system of claim 1, wherein the PD is configured for optional reception of power from the first wire set or the second wire set.

27. The PoE system of claim 1, wherein the PSE is configured to provide the first wire set with power from a first power source, and to provide the second wire set with power from a second power source separate from the first power source.

28. The PoE system of claim 1, wherein power usage on the first wire set differs from power usage on the second wire set.

29. The PoE system of claim 1, wherein maximum current limit established for the first wire set differs from maximum current limit established for the second wire set.

30. The PoE system of claim 1, wherein minimum current usage on the first wire set differs from minimum current usage on the second wire set.

31. The PoE system of claim 1, wherein the first wire set is designated as a master set and the second wire set is designated as a slave set, and a slave operation associated with the slave set is tied to a master operation associated with the master set.

32. The PoE system of claim 31, wherein the slave operation is conducted when the master operation is deemed acceptable.

33. A local area network comprising:
at least a pair of network nodes,
a network hub, and
communication cabling for connecting the network nodes to the network hub to provide data communications, the communication cabling having a first wire set composed of first and second pairs of conductors and a second wire set composed of third and fourth pairs of conductors,
the network hub having a power supply device for providing power to a load over both the first wire set and the second wire set.

34. A method of providing power over a communication link including a first wire set composed of first and second pairs of conductors and a second wire set composed of third and fourth pairs of conductors, comprising the steps of:
establishing power over the first wire set, and
thereafter, establishing power over the second wire set.

35. The method of claim 31, wherein the power over the first wire set is established in accordance with the IEEE 802.3af standard.
